(19) United States
(12) Patent Application Publication
(10) Pub. No.: US 2012/0136896 A1
(43) Pub. Date: May 31, 2012

(54) SYSTEM AND METHOD FOR IMPUTING MISSING VALUES AND COMPUTER PROGRAM PRODUCT THEREOF

(76) Inventors: Shin-Mu TSENG, Tainan City (TW); Bai-En SHIE, Zhonghe City (TW); Ja-Hwung SU, Kaohsiung County (TW); Chih-Hua HSU, Kaohsiung City (TW)

(21) Appl. No.: 12/976,571

(22) Filed: Dec. 22, 2010

(30) Foreign Application Priority Data
Nov. 26, 2010 (TW) 099141008

(51) Int. Cl. G06F 17/30

(52) U.S. Cl. 707/780; 707/E17.014

(57) ABSTRACT

A system and a method for imputing missing values and a computer program product thereof are applicable to a data matrix. The system includes a storage unit having the data matrix and a computing device. The computing device finds complete and incomplete data transactions from the data matrix, finds at least one target data transaction approximate to each incomplete data transaction from the complete data transactions, and obtains known data at corresponding positions to compute an initial estimated data to replace unknown data. Then, a correction data transaction containing the initial estimated data is selected from the incomplete data transactions, a rough set of the selected initial estimated data is found in a manner of grouping same data into one group, and a numerical value correlated to the initial estimated data is found and used to compute an imputed data, so as to impute the imputed data into the original estimated data.

### CROSS-REFERENCE TO RELATED APPLICATION

This application claims the benefit of Taiwan Patent Application No. 099141008, filed on Nov. 26, 2010, which is hereby incorporated by reference for all purposes as if fully set forth herein.

### BACKGROUND OF THE INVENTION

1. Field of Invention

The present invention relates to a data imputation system and method, and more particularly to a system and a method for imputing missing values and a computer program product thereof.

2. Related Art

Nowadays, for collection and processing of data for biological and medical use, a large volume of data is usually collected at remote ends or from different places, followed by summarization or data processing and analysis. For example, a technology for collecting gene data is to use a chip or an inspection apparatus to inspect tissues of a living body or collect physiological signals of a living body, for example, cells, body liquid, or physiological signals of biological motion of an animal or a plant, and various other different gene expression data, and the gene expression data will be recorded in a data matrix in a storage unit of the chip or inspection apparatus.

However, as for gene data collection described above, when the gene expression data is collected for medical analysis, missing of gene expression values may occur. Currently, if missing of a value occurs to the gene expression data in medical analysis, many analyses cannot be carried out, so that the gene expression data is considered invalid, and incomplete data transactions are deleted. However, if too many data transactions are deleted, the analysis is inaccurate or cannot be carried out, and in this case, the most commonly used method is to use the same or a different chip or inspection device to collect gene expression data again. It is obvious that, both the operation of collecting data again and the use of other chips or inspection apparatuses result in wasting of precious medical data. On the other hand, current data imputation technologies mostly propose linear regression, neural network and K-nearest neighborhood (KNN). However, it is difficult to apply the linear regression and neural network to categorical data, and if different value imputation technologies are used for correlated data matrixes, the analytical result will be doubtable. On the other hand, the KNN is not applicable to data matrixes with a large data volume, and requires a long time for searching data, and thus has a rather small range of applications.

Therefore, how to provide a value imputation method that is applicable to various data matrixes, does not require a long time for data processing, and has a low error rate is a problem to be considered by manufacturers.

### SUMMARY OF THE INVENTION

Accordingly, the present invention is directed to a system and a method for imputing missing values of unknown data attributes by pairing highly similar data transactions to obtain correlated initial estimated data and a computer program product thereof.

To solve the above system problems, the present invention provides a system for imputing missing values, comprising a storage unit and a computing device. The storage unit stores a data matrix, the data matrix comprises a plurality of data transactions and a plurality of data attributes, the data transactions comprise a plurality of complete data transactions and a plurality of incomplete data transactions, and each incomplete data transaction comprises at least one unknown data. The computing device comprises an analysis program and a processor, and the processor is for reading and using the analysis program to analyze the data matrix.

The processor finds at least one target data transaction approximate to each incomplete data transaction from the complete data transactions, obtains at least one known data from the at least one target data transaction to compute an initial estimated data, uses the initial estimated data to replace the corresponding unknown data and serve as a plurality of data to be corrected, finds a specific data to be corrected from the data to be corrected, selects a first designated data attribute and a second designated data attribute respectively having an approximate variation with the specific data to be corrected from the data attributes, finds a data transaction group according to data in the transaction to which the specific data to be corrected belongs in a manner of grouping same data into one group, divides the data transactions into a plurality of subgroups according to a attribute combination of the data transaction group and the second designated data attribute in a manner of grouping same data into one group, finds at least one target group having data matching the data transaction group from the subgroups, uses data of the specific data attribute to be corrected corresponding to the at least one target group to compute an imputed data for imputing the attribute of the specific data to be corrected, and judges whether the transaction to which the specific data to be corrected belongs has other data to be corrected, so as to determine whether to designate another specific data to be corrected.

To solve the above method problems, the present invention provides a method for imputing missing values, applicable to a data matrix, wherein the data matrix comprises a plurality of data transactions and a plurality of data attributes. The method comprises: finding a plurality of complete data transactions and a plurality of incomplete data transactions from the data matrix, each incomplete data transaction comprising at least one unknown data; respectively obtaining at least one target data transaction approximate to each incomplete data transaction from the complete data transactions; obtaining at least one known data from the at least one target data transaction corresponding to the incomplete data transaction according to a attribute position of each unknown data in the incomplete data transaction, and using the at least one known data to compute an initial estimated data; using the initial estimated data to replace the corresponding unknown data and serve as a plurality of data to be corrected; designating a specific data to be corrected from the data to be corrected, the transaction to which the specific data to be corrected belongs being a correction data transaction; selecting a first designated data attribute having the most approximate variation with the specific data to be corrected from the data attributes, and finding a data transaction group comprising the correction data transaction according to data in the transaction to which the specific data to be corrected belongs in a manner of grouping same data into one group; selecting a second designated data attribute having a secondary approximate variation with the specific data to be corrected from the data attributes, and dividing the data transactions into a plurality of subgroups according to an attribute combination of the attribute to which the specific data to be corrected belongs and the second designated data attribute in a manner of grouping same data into one group; finding at least one target group having data matching the data transaction group from the subgroups, and using data of the specific data attribute to be corrected corresponding to the at least one target group to compute an imputed data for imputing the attribute of the specific data to be corrected; and judging whether the transaction to which the specific data to be corrected belongs has other data to be corrected, so as to determine whether to designate another specific data to be corrected.

The present invention further provides a computer program product, read by a computing device to execute the above method for imputing missing values, and the process is as described above, so that the details will not be described herein again.

The present invention is characterized in that, by combining a Pearson Correlation Coefficient (PCC) with a rough set, a two-stage data imputation technology is used to impute in high-precision estimated data and then correct the imputed data, which helps to improve the accuracy and validity of analysis. Furthermore, such a technology can impute missing values into data, and a lot of data can be maintained, so that the data after imputing can be applied to more data analyses rather than being discarded, so as to avoid repeated collection of gene expression data, thereby saving the medical resources, the labor force and the technical cost.

### BRIEF DESCRIPTION OF THE DRAWINGS

The present invention will become more fully understood from the detailed description given herein below for illustration only, and thus are not limitative of the present invention, and wherein:

FIG. 1A is a block diagram of a system according to an embodiment of the present invention;

FIG. 1B is a schematic flow chart of a method for imputing missing values according to an embodiment of the present invention;

FIG. 1C and FIG. 1D are schematic detailed flow charts of the method of FIG. 1B;

FIG. 2 is an exemplary view of a first data matrix according to an embodiment of the present invention;

FIG. 3 is a schematic view of imputing estimated values of the data matrix according to an embodiment of the present invention;

FIG. 4 is a schematic view of designating a specific data to be corrected of the data matrix according to an embodiment of the present invention;

FIG. 5A is a schematic view of selecting a first designated data attribute of the data matrix according to an embodiment of the present invention;

FIG. 5B is a schematic view of dividing a data transaction group of the data matrix according to an embodiment of the present invention;

FIG. 6A is a schematic view of dividing another data transaction group of the data matrix according to an embodiment of the present invention;

FIG. 6B is a schematic view of dividing subgroups of the data matrix according to an embodiment of the present invention;

FIG. 7 is a schematic view of corresponding relations of groups of the data matrix according to an embodiment of the present invention;

FIG. 8 is an exemplary view of a second data matrix according to an embodiment of the present invention;

FIG. 9 is a schematic view of imputing estimated values of the second data matrix according to an embodiment of the present invention; and

FIG. 10 is a schematic view of imputing data of the second data matrix according to an embodiment of the present invention.

### DETAILED DESCRIPTION OF THE INVENTION

Preferred embodiments of the present invention are described in detail below with reference to the accompanying drawings.

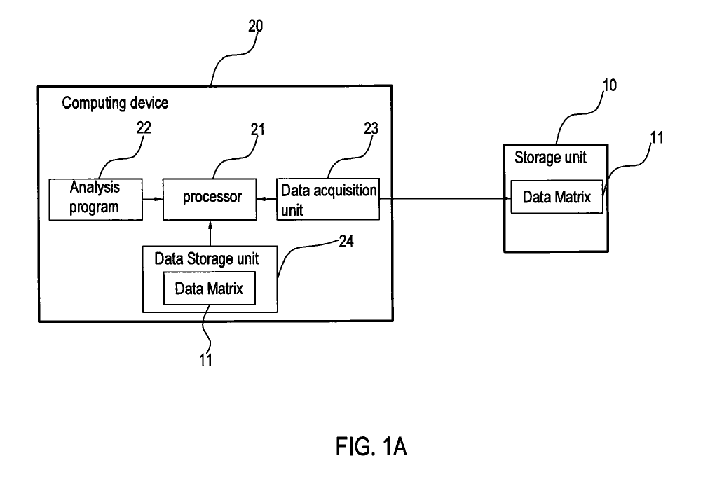

FIG. 1A is a block diagram of a system according to an embodiment of the present invention. Referring to FIG. 1A, the system includes a computing device 20 and a storage unit 10, the storage unit 10 stores a data matrix 11, and the computing device 20 has a processor 21, a data acquisition unit 23 and an analysis program 22 built therein. The data acquisition unit 23 is used for obtaining the data matrix 11 from the storage unit 10, and the processor 21 uses the analysis program 22 to analyze the data matrix 11. However, the data matrix 11 may also be acquired in advance and stored in a data storage unit 24 of the computing device 20, such that the processor 21 directly reads the data matrix 11 in the data storage unit 24 to execute the following operation of imputing missing values.

The computing device 20 may be an ordinary electronic device with data processing capability, such as various types of computers, personal computers, notebook computers, servers, workstations or personal digital assistants (PDAs). The storage unit 10 may be an element or apparatus with storage capability, such as a chip, memory, hard disk or flash drive, and may also be disposed in or integrated with other apparatuses, such as various inspection apparatuses (for inspecting a biopsy to generate various inspection data), health care boxes (for collecting various physiological signals of human body) or signal collection apparatuses (for collecting various signals).

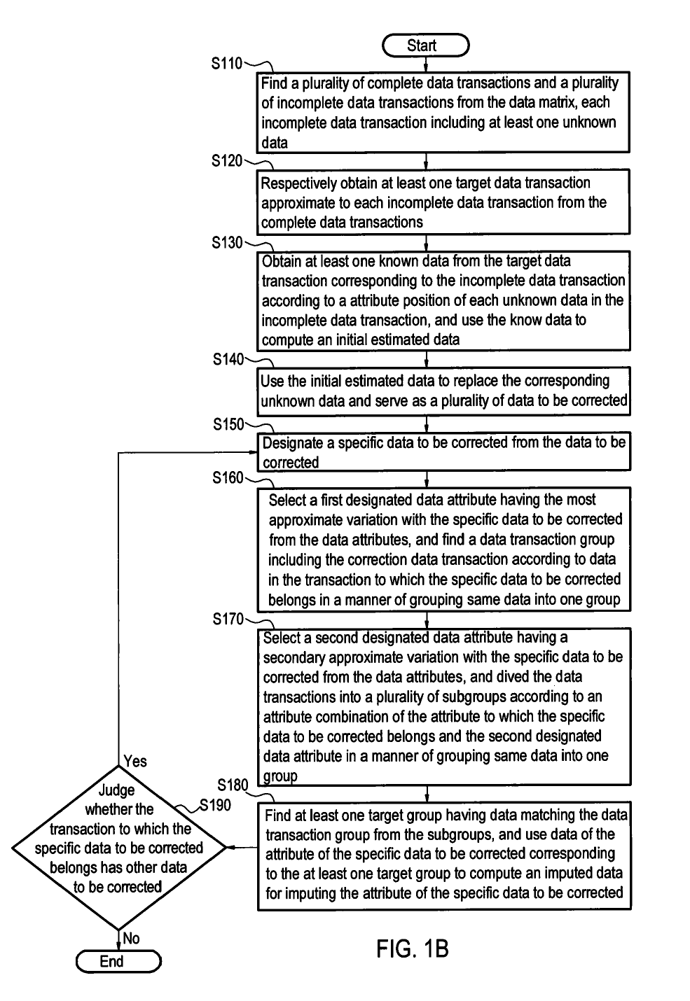

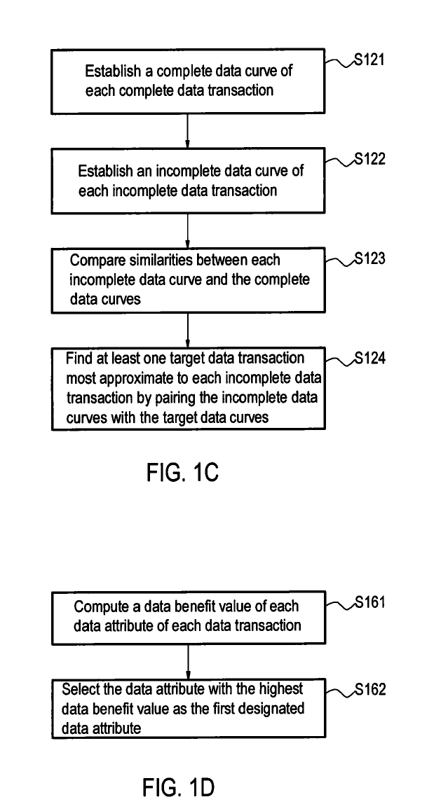

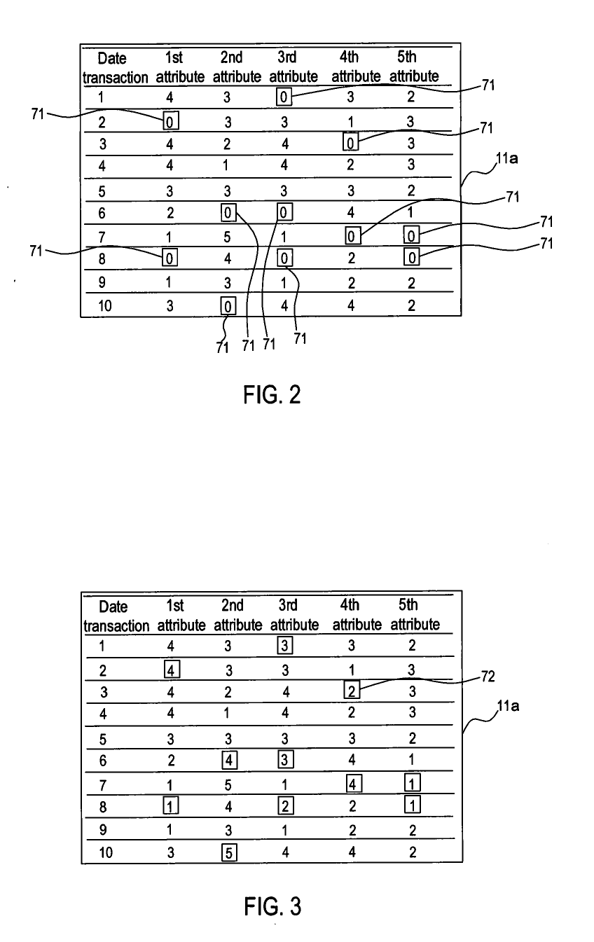

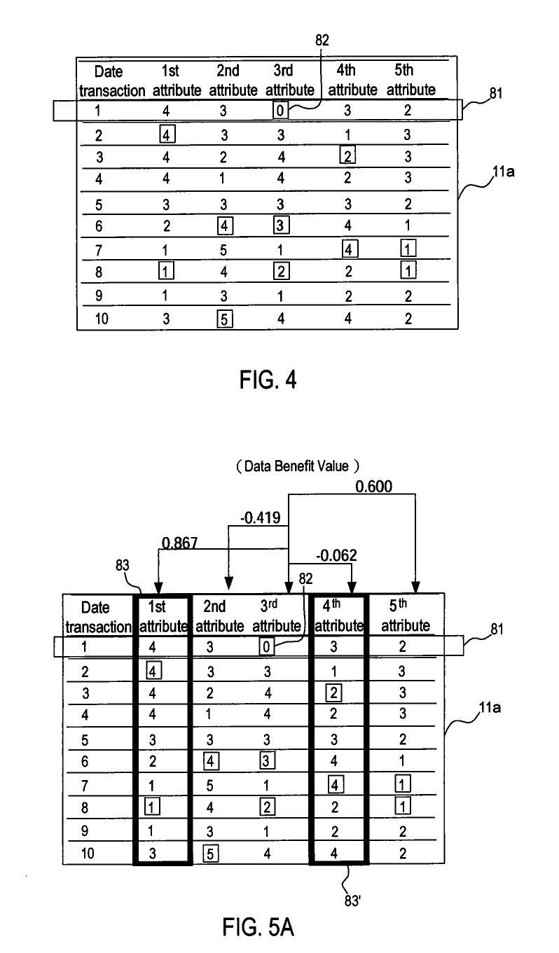

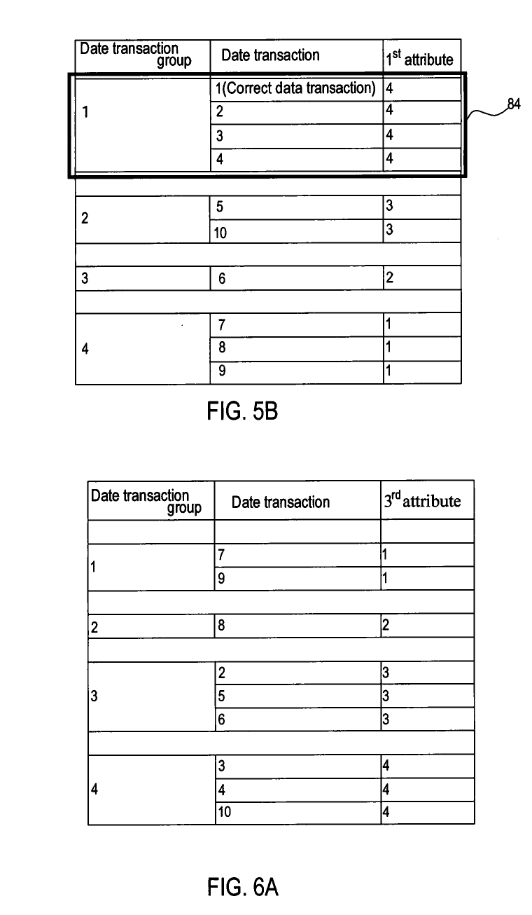

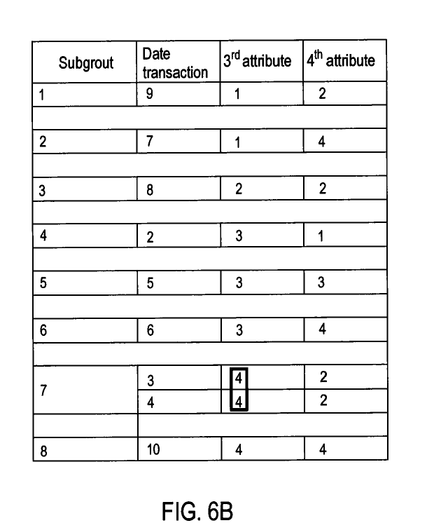

FIG. 1B is a schematic flow chart of a method for imputing missing values according to an embodiment of the present invention, which is applicable to impute missing values of a data matrix; FIG. 1C and FIG. 1D are schematic detailed flow charts of the method of FIG. 1B; FIG. 2 is an exemplary view of a first data matrix according to an embodiment of the present invention; FIG. 3 is a schematic view of imputing estimated values of the data matrix according to an embodiment of the present invention; FIG. 4 is a schematic view of designating a specific data to be corrected of the data matrix according to an embodiment of the present invention; FIG. 5A is a schematic view of selecting a first designated data attribute of the data matrix according to an embodiment of the present invention; FIG. 5B is a schematic view of dividing a data transaction group of the data matrix according to an embodiment of the present invention; FIG. 6A is a schematic view of dividing another data transaction group of the data matrix according to an embodiment of the present invention; FIG. 6B is a schematic view of dividing subgroups of the data matrix according to an embodiment of the present invention; and FIG. 7 is a schematic view of correspondence of groups of the data matrix according to an embodiment of the present invention.

As shown in FIG. 1A, the method includes two stages, one is to use a Pearson Correlation Coefficient (PCC) to preliminarily impute initial estimated data into unknown data attributes, and the other is to use a rough set to find values approximate to the missing values, so as to correct the original estimated data, and the method includes the following steps.

A plurality of complete data transactions and a plurality of incomplete data transactions are found from the data matrix, each incomplete data transaction including at least one unknown data (Step S110). As shown in FIG. 2, taking a numerical data matrix 11a as an example, the data matrix 11a includes a plurality of data transactions and a plurality of data attributes.

It is assumed that the data matrix 11a includes 10 data transactions, in which the 4^{th}, 5^{th}, and 9^{th} data transactions are complete data transactions, the 1^{st}, 2^{nd}, 3^{rd}, 6^{th}, 7^{th}, 8^{th}, and 10^{th} data transactions are incomplete data transactions, and each incomplete data transaction includes at least one unknown data 71 (represented as 0 in the figure), for example, the unknown data of the 1^{st} data transaction is the 3^{rd} attribute, the unknown data of the 2^{nd} data transaction is the 1^{st} attribute, the unknown data of the 3^{rd} data transaction is the 4^{th} attribute, the unknown data of the 6^{th} data transaction is the 2^{nd} and 3^{rd} attributes, and so on.

At least one target data transaction approximate to each incomplete data transaction is respectively obtained from the complete data transactions (Step S120). This step is described with reference to FIG. 1C which is a schematic flow chart of comparing data transaction curves according to an embodiment of the present invention, and includes the following steps.

A complete data curve of each complete data transaction is established (Step S121), and an incomplete data curve of each incomplete data transaction is established (Step S122).

Here, each complete data transaction is analyzed first, and data of the complete data transaction is projected to a two-dimensional coordinate system, so as to obtain a complete data curve corresponding to each complete data transaction. Likewise, each incomplete data transaction is analyzed, the existence of unknown data is ignored, and data of the incomplete data transaction is projected to a two-dimensional coordinate system, so as to obtain an incomplete data curve corresponding to each incomplete data transaction.

Similarities between each incomplete data curve and the complete data curves are compared, so as to find at least one approximate target data curve corresponding to each incomplete data curve from the complete data curves (Step S123). Here, each incomplete data curve is compared with all the complete data curves, and after the incomplete data curves are compared with the complete data curves one by one, approximation ratios of the most-relevant complete data curves corresponding to the incomplete data curves are generated. Afterwards, according to the approximation ratios, at least one approximate target data curve can be obtained by pairing with each incomplete data curve.

Afterwards, at least one target data transaction most approximate to each incomplete data transaction is found by pairing the incomplete data curves with the target data curves (Step S124). The target data curves are those generated by mapping the target data transactions to the two-dimensional coordinate system as described herein, so pairing of the incomplete data transactions and the target data transactions can be derived from pairing of the incomplete data curves with the target data curves.

However, Step S120 may also adopt a method of comparing numerical values of attributes of the same order to determine differences, so as to determine data differences between the incomplete data transactions and the complete data transactions, and thus determine data similarities between the incomplete data transactions and the complete data transactions, thereby achieving pairing of the incomplete data transactions and the complete data transactions having high similarities, and since this method is well known to those of ordinary skill in the art of data comparison, the details will not be described herein.

At least one known data is obtained from the target data transaction corresponding to the incomplete data transaction according to a attribute position of each unknown data in the incomplete data transaction, and is used to compute an initial estimated data (Step S130), and the initial estimated data is used to replace the corresponding unknown data and serve as a plurality of data to be corrected (Step S140).

In this step, the initial estimated data is a mean of the known data of the target data transaction corresponding to the incomplete data transaction to which the unknown data attribute to be imputed by the initial estimated data in advance belongs. For example, data of the data transactions shown in FIG. 2 and FIG. 3 are numerical data, the 1^{st} data transaction has the unknown data 71 in the 3^{rd} attribute, and the complete data transaction most approximate to the 1^{st} data transaction is the 5^{th} data transaction, so the 3^{rd} attribute of the 1^{st} data transaction takes 3 (3/1=3) as the initial estimated data 72. For another example, the 2^{nd} data transaction has the unknown data 71 in the 1^{st} attribute, and the complete data transaction most approximate to the 2^{nd} data transaction is the 4^{th} data transaction, so the 1^{st} attribute of the 2^{nd} data transaction takes 4 (4/1=4) as the initial estimated data 72. For another example, the 3^{rd} data transaction has the unknown data 71 in the 4^{th} attribute, and the complete data transactions most approximate to the 3^{rd} data transaction are the 4^{th} data transaction and the 9^{th} data transaction, so the 4^{th} attribute of the 3^{rd} data transaction takes 2 ((2+2)/2=2) as the initial estimated data 72. By analogy, the unknown data 71 is replaced by the correlated initial estimated data 72, so as to complete the first-stage imputing operation on the unknown data, and the imputed data is considered the data to be corrected for subsequent use, as shown in FIG. 3.

Then, an operation of correcting the initial estimated data is performed, as shown in FIG. 1B, after Step S140, a specific data to be corrected is designated from the data to be corrected (Step S150), the transaction to which the specific data to be corrected belongs being a correction data transaction. Referring to FIG. 4 at the same time, one is selected from all the data to be corrected into which the initial estimated data is imputed previously to serve as the specific data to be corrected for current data correction, the transaction to which the specific data to be corrected belongs being a correction data transaction. Next, the 1^{st} data transaction is used as an uncorrected correction data transaction 81, the 3^{rd} attribute of the 1^{st} data transaction records a specific data to be corrected 82, which is replaced by 0 here.

Then, a first designated data attribute having the most approximate variation with the specific data to be corrected is selected from the data attributes, and a data transaction group including the correction data transaction is found according to data in the transaction to which the specific data to be corrected belongs in a manner of grouping same data into one group (Step S160). The data variation of the attribute to which the specific data to be corrected is based on data benefit values of each attribute, and as for computation of the data benefit values, reference is made to FIG. 1D which is a schematic flow chart of finding a data transaction group according to an embodiment of the present invention, including the following steps: first, a data benefit value of each data attribute of each data transaction is computed (Step S161), and the data attribute with the highest data benefit value is selected as the first designated data attribute (Step S162). The data benefit values are computed in the following manner:

$$cor ( i , j ) = \frac{{\sum }_{k = 1}^{m} ( {v}_{i , k} - \frac{{\sum }_{l = 1}^{m} {v}_{i , l}}{m} ) ( {v}_{j , k} - \frac{{\sum }_{l = 1}^{m} {v}_{j , l}}{m} )}{\sqrt{{\sum }_{k = 1}^{m} {( {v}_{i , k} - \frac{{\sum }_{l = 1}^{m} {v}_{i , l}}{m} )}^{2} {\sum }_{k = 1}^{m} {( {v}_{j , k} - \frac{{\sum }_{l = 1}^{m} {v}_{j , l}}{m} )}^{2}}} \qquad ( Equation 1 )$$

Hence, {cor(1, the number of unknown data attributes of the correction data transaction), cor(2, the number of unknown data attributes of the correction data transaction), cor(4, the number of unknown data attributes of the correction data transaction), cor(5, the number of unknown data attributes of the correction data transaction)}={0.867, −0.419, −0.062, 0.600}, in which the number of unknown data attributes of the correction data transaction 81 is 3. It can be seen from this embodiment that the 1^{st} data attribute has the highest data benefit value, and thus the 1^{st} data attribute is considered the first designated data attribute 83. Therefore, for data of the 1^{st} data attribute, all the data transactions are divided into groups in a manner of grouping same data into one group, that is, as shown in FIG. 5A and FIG. 5B, according to data of the 1^{st} attribute (that is, the 1^{st} data attribute or the first designated data attribute 83) of each data transaction, all the data transactions are divided into four groups, while the 1^{st} data transaction, the 2^{nd} data transaction, the 3^{rd} data transaction and the 4^{th} data transaction are grouped into the same data transaction group 84.

A second designated data attribute having a secondary approximate variation with the specific data to be corrected is selected from the data attributes, and the data transactions are divided into a plurality of subgroups according to an attribute combination of the attribute to which the specific data to be corrected belongs and the second designated data attribute in a manner of grouping same data into one group (Step S170).

In this step, in order to reduce the complexity of data comparison, for the data attribute formed by the attribute to which the specific data to be corrected 82 of the correction data transaction belongs, all the data transactions may be divided into groups in a manner of grouping same data into one group. As shown in FIG. 6A and FIG. 6B, the attribute to which the specific data to be corrected of the correction data transaction belongs is at the 3^{nd} attribute, so that for data of the 3^{rd} data attribute, each data transaction is divided into 4 groups in a manner of grouping same data into one group. However, since the specific data to be corrected 82 of the correction data transaction is 0, whether the correction data transaction forms one group does not affect subsequent operations, and thus, the correction data transaction is ignored.

As for FIG. 5A, the 4^{th} attribute has the 2^{nd} highest data benefit value, and thus the 4^{th} attribute is considered a second designated data attribute 83′. Therefore, the 3^{rd} attribute and the 4^{th} attribute of the 1^{st} data transaction are used as an attribute combination for reference, so as to compare data formed by the 3^{rd} attribute and the 4^{th} attribute of each data transaction, such that the four groups divided previously are further divided into 8 subgroups. Since the data combinations of the 3^{rd} attributes and the 4^{th} attributes of the 3^{rd} data transaction and the 4^{th} data transaction are identical (both are 4,2; framed areas in the figure), the 3^{rd} data transaction and the 4^{th} data transaction are grouped into the same subgroup (the 7^{th} subgroup 97 in the figure). Likewise, since the specific data to be corrected 82 of the correction data transaction 81 is 0, whether the correction data transaction 81 forms one group does not affect subsequent operations, and thus, the correction data transaction 81 is ignored.

At least one target group having data matching the data transaction group is found from the subgroups, and data of the attribute of the specific data to be corrected corresponding to the at least one target group is used to compute an imputed data for imputing the attribute of the specific data to be corrected (Step S180). This step is performed in the following manner: when a data transaction of a specific group in the subgroups is consistent with any data transaction in the data transaction group, judging that the specific group is the target group; and at this time, designating data attributes to be corrected as designated data attributes.

As shown in FIG. 7, the data transaction group 84 includes the 1^{st} data transaction, the 2^{nd} data transaction, the 3^{rd} data transaction and the 4^{th} data transaction. However, the 4^{th} subgroup 94 includes the 2^{nd} data transaction, and the 7^{th} subgroup 97 includes the 3^{rd} data transaction and the 4^{th} data transaction; mathematically, the 4^{th} subgroup 94 and the 7^{th} subgroup 97 are contained by the data transaction group 84, that is, the 4^{th} subgroup 94 and the 7^{th} subgroup 97 are the specific groups, and the 3^{rd} attribute of the 4^{th} subgroup 94 and the 3^{rd} attribute of the 7^{th} subgroup 97 are the designated data attributes, numerical values of which are computed and then used in the data attributes to be corrected. Therefore, the imputed data to be imputed to the data attributes to be corrected of the 1^{st} data transaction is a sum of the numerical values of the 3^{rd} attribute of the 4^{th} subgroup 94 and the 3^{rd} attribute of the 7^{th} subgroup 97 divided by 2, that is, (3+4)/2=3.5. In other words, the imputed data is “sum of numerical values of the specific data attributes to be corrected of the selected subgroups/number of the selected subgroups”. Therefore, a numerical value to be imputed to the specific data attribute to be corrected of the 1^{st} data transaction is 3.5.

Afterwards, it is judged whether the transaction to which the specific data to be corrected belongs has other data to be corrected (Step S190). When the transactions to which the specific data to be corrected are all corrected, the operation is ended; otherwise, another specific data to be corrected is designated, that is, the process returns to (Step S150), so as to continue the process from Step S150 to Step S190, until all the specific data to be corrected is corrected.

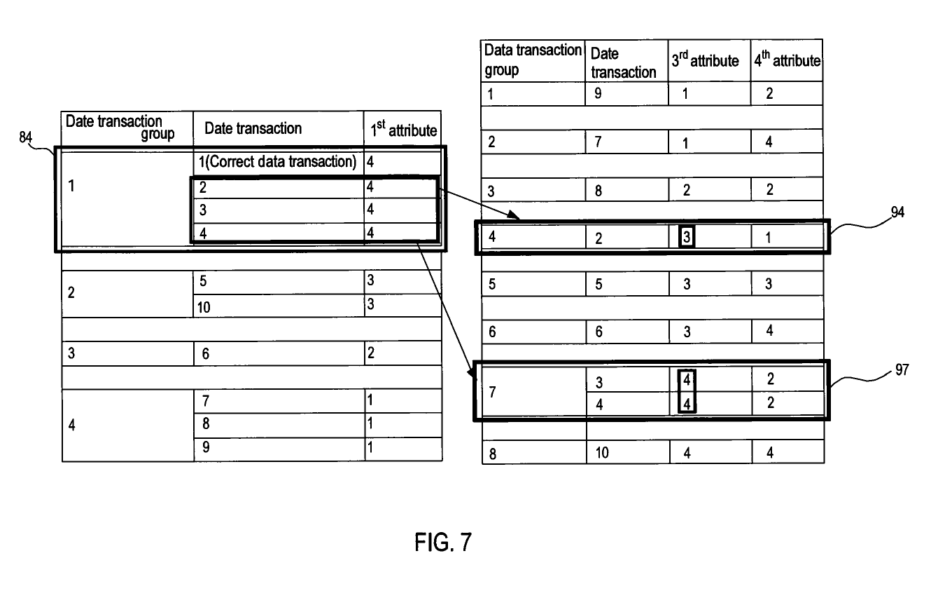

Reference is made to FIG. 8 to FIG. 10 which are schematic views of variation of a second data matrix and a data transaction group, and is also made to FIG. 1A to FIG. 1D for ease of understanding. FIG. 8 is an exemplary view of a second data matrix according to an embodiment of the present invention by taking a categorical data matrix 11b as an example. It is assumed that the data matrix includes 9 data transactions, in which the 5^{th} data transaction, the 7^{th} data transaction and the 9^{th} data transaction are incomplete data transactions, and each incomplete data transaction includes at least one unknown data 71′, for example, the 5^{th} data transaction has the unknown data 71′ in the 1^{st} attribute, the 7^{th} data transaction has the unknown data 71′ in the 2^{nd} attribute, the 9^{th} data transaction has the unknown data 71′ in the 1^{st} attribute, and so on.

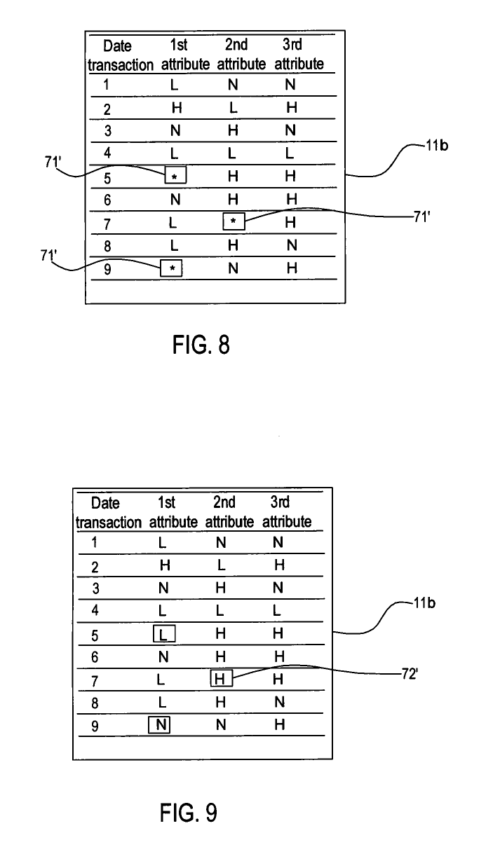

Likewise, through Step S110 to Step S140, all the unknown data of the data matrix shown in FIG. 8 will be replaced by the correlated initial estimated data, so as to complete the first-stage imputing operation on the unknown data, that is, as shown in FIG. 9. For example, computation of the initial estimated data may be performed by using a PCC equation, and the PCC equation is mainly to analyze variation of data values in each attribute and mean data values of similar transactions to compute mean values of the transactions with missing values, and then compute the initial estimated data of the missing values according to the mean values of the transaction with missing values.

The PCC equation is as follows:

$$sim ( u , v ) = \frac{{\sum }_{i ∈ l} ( {r}_{u , i} - {\overline{r}}_{u} ) ( {r}_{v , i} - {\overline{r}}_{v} )}{\sqrt{{\sum }_{i ∈ l} {( {r}_{u , i} - {\overline{r}}_{u} )}^{3}} \sqrt{{\sum }_{i ∈ l} {( {r}_{v , i} - {\overline{r}}_{v} )}^{2}}} , \qquad ( 1 )$$

where I=Iᵤ∩Iᵥ.

where, u and v respectively represent two data transactions, r_{u,i} and r_{v,i} are respectively values of the i^{th} attribute of the u^{th} and v^{th} transactions, and r̅ᵤ̅ and r̅ᵥ̅ are the average values of the u^{th} and v^{th} transactions, respectively I is a set of attributes with values of the two data transactions, and taking FIG. 2 as an example, a similarity between the 2^{nd} transaction and the 3^{rd} transaction is computed as follows

r̅₂̅=2.5, r̅ₛ̅=3.25, similarity(the 2^{nd} transaction, the 3^{rd} transaction)=((3−2.5)(2−3.25)+(3−2.5)(4−3.25)+(3−2.5)(3−3.25))/((√(3−2.5)2+(3−2.5)2+(3−2.5)2)(√(2−3.25)2+(4−3.25)2+(3−3.25)2)=0.125/(√0.25+0.25+0.25)(√0.5625+0.5625+0.0625))=0.14.

Next, a result is estimated according to a target attribute value of the most similar transaction, and a commonly used equation is defined as follows:

$${P}_{u , i} = {\overline{r}}_{u} + \frac{{\sum }_{v ∈ U} {S}_{u , v} * ( {r}_{v , i} - {\overline{r}}_{v} )}{{\sum }_{v ∈ U} \vert {S}_{u , v} \vert} , \qquad ( 1 )$$

where U=all similar users with u.

where, Pu,i is a target attribute value of the i^{th} attribute of the u^{th} transaction, and is a mean attribute value of the u^{th} transaction, S_{u,v} represents the similarity between the u^{th} transaction and the v^{th} transaction, and taking FIG. 2 as an example, if the value of the 1^{st} attribute of the 2^{nd} transaction needs to be estimated, other data transactions most correlated to the 2^{nd} transaction must be determined first, and as can be seen from FIG. 2, the 1^{st} transaction is most similar to the 2^{nd} transaction, and the similarity calculated is 0.353, and thus the final estimated result is P2,1=2.5+(0.353*(4−3))/0.353=3.5.

However, different from the foregoing embodiment, data of the data transactions in the foregoing embodiment are numerical data, and the initial estimated data 72′ is a mean of the correlated known data of the target data transaction corresponding to the incomplete data transaction to which the unknown data 71′ to be imputed by the initial estimated data 72′ in advance belongs. However, data of the data transactions in this embodiment are categorical data, and the initial estimated data 72′ is data having the highest frequency of occurrence in the correlated known data of the target data transaction corresponding to the incomplete data transaction to which the unknown data 71′ to be replaced by the initial estimated data 72′ belongs. For example, assuming that the target data transactions corresponding to the 5^{th} data transaction are the 1^{st} data transaction to the 4^{th} data transaction, and L has the highest frequency of occurrence in the 1^{st} attributes of the data transactions, it is estimated that the numerical value of the 1^{st} attribute of the 5^{th} data transaction is L.

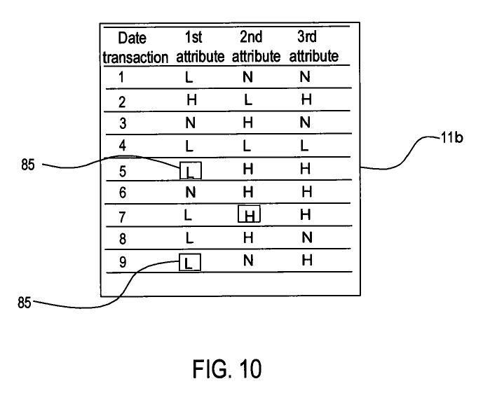

Similarly, after the initial estimated data 72′ is preliminarily imputed to the second data matrix shown in FIG. 9, Step S150 to Step S190 are also performed to correct the specific data to be corrected of each incomplete data transaction, so as to compute the imputed data 85 for replacement, as shown in FIG. 10.

In this embodiment, Step S150 to Step S190 may be performed with reference to the prior art, for example, [T. P. Hong, L. H. Tseng, and S. L. Wang, “Learning rules from incomplete training examples by rough sets”, Expert Systems with Applications, Vol. 22, pp. 285, 2002].

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A system for imputing missing values, comprising:
a storage unit, storing a data matrix, wherein the data matrix comprises a plurality of data transactions and a plurality of data attributes, the data transactions comprise a plurality of complete data transactions and a plurality of incomplete data transactions, and each incomplete data transaction comprises at least one unknown value; and
a computing device, comprising:
an analysis program; and
a processor, for reading and using the analysis program to analyze the data matrix, wherein the processor finds at least one target data transaction approximate to one incomplete data transaction from the complete data transactions for each incomplete data transaction, obtains at least one known data from the at least one target data transaction to compute an initial estimated data, uses the initial estimated data to replace the corresponding unknown data and serve as a plurality of data to be corrected, finds specific data to be corrected from the data to be corrected, selects a first designated data attribute and a second designated data attribute respectively having an approximate variation with the specific data to be corrected from the data attributes, finds a data transaction group according to data in the transaction to which the specific data to be corrected belongs in a manner of grouping same data into one group, divides the data transactions into a plurality of subgroups according to an attribute combination of the data transaction group and the second designated data attribute in a manner of grouping same data into one group, finds at least one target group having data matching with the data transaction group from the subgroups, uses data of the specific data attribute to be corrected corresponding to the at least one target group to compute an imputed data for imputing the attribute of the specific data to be corrected, and judges whether the transaction to which the specific data to be corrected belongs has other data to be corrected, so as to determine whether to designate another specific data to be corrected.

2. The system for imputing missing values according to claim 1, wherein the processor establishes a complete data curve of each complete data transaction, establishes an incomplete data curve of each incomplete data transaction, and compares similarities between each incomplete data curve and the complete data curves, so as to find at least one approximate target data curve corresponding to each incomplete data curve from the complete data curves; and finds at least one target data transaction most approximate to each incomplete data transaction by pairing the incomplete data curves with the target data curves.

3. The system for imputing missing values according to claim 1, wherein the processor judges, when a data transaction of a specific group in the subgroups is consistent with any data transaction in the data transaction group, that the specific group is the target group, and then designates data attributes to be corrected as designated data attributes.

4. The system for imputing missing values according to claim 1, wherein data of the data transactions are numerical data, and the imputed data is a mean of numerical values in the designated data attribute of the at least one target group.

5. The system for imputing missing values according to claim 1, wherein data of the data transactions are categorical data, and the initial estimated data is data in the at least one known data of the at least one target data transaction corresponding to the incomplete data attribute to which the unknown data attribute to be imputed by the initial estimated data in advance belongs.

6. A method for imputing missing values, applicable to a data matrix, wherein the data matrix comprises a plurality of data transactions and a plurality of data attributes, the method comprising:
finding a plurality of complete data transactions and a plurality of incomplete data transactions from the data matrix, each incomplete data transaction comprising at least one unknown data;
respectively obtaining at least one target data transaction approximate to each incomplete data transaction from the complete data transactions;
obtaining at least one known data from the at least one target data transaction corresponding to the incomplete data transaction according to an attribute position of each unknown data in the incomplete data transaction, and using the at least one known data to compute an initial estimated data;
using the initial estimated data to replace the corresponding unknown data and serve as a plurality of data to be corrected;
designating a specific data to be corrected from the data to be corrected, the transaction to which the specific data to be corrected belongs being a correction data transaction;
selecting a first designated data attribute having the most approximate variation with the specific data to be corrected from the data attributes, and finding a data transaction group according to data in the transaction to which the specific data to be corrected belongs in a manner of grouping same data into one group;
selecting a second designated data attribute having a secondary approximate variation with the specific data to be corrected from the data attributes, and dividing the data transactions into a plurality of subgroups according to an attribute combination of the attribute to which the specific data to be corrected belongs and the second designated data attribute in a manner of grouping same data into one group;
finding at least one target group having data matching the data transaction group from the subgroups, and using data of the specific data attribute to be corrected corresponding to the at least one target group to compute an imputed data for imputing the attribute of the specific data to be corrected; and
judging whether the transaction to which the specific data to be corrected belongs has other data to be corrected, so as to determine whether to designate another specific data to be corrected.

7. The method for imputing missing values according to claim 6, wherein the step of respectively obtaining the at least one target data transaction approximate to each incomplete data transaction from the complete data transactions comprises:
establishing a complete data curve of each complete data transaction;
establishing an incomplete data curve of each incomplete data transaction;
comparing similarities between each incomplete data curve and the complete data curves, so as to find at least one approximate target data curve corresponding to each incomplete data curve from the complete data curves; and
finding at least one target data transaction most approximate to each incomplete data transaction by pairing the incomplete data curves with the target data curves.

8. The method for imputing missing values according to claim 6, wherein the step of finding the at least one target group having data matching the data transaction group from the subgroups comprises:
when a data transaction of a specific group in the subgroups is consistent with any data transaction in the data transaction group, judging that the specific group is the target group; and
designating data attributes to be corrected as designated data attributes.

9. The method for imputing missing values according to claim 6, wherein data of the data transactions are numerical data, and the imputed data is a mean of numerical values in the designated data attribute of the at least one target group.

10. The method for imputing missing values according to claim 6, wherein data of the data transactions are categorical data, and the initial estimated data is data in the at least one known data of the at least one target data transaction corresponding to the incomplete data attribute to which the unknown data attribute to be imputed by the initial estimated data in advance belongs.

11. A computer program product, read by a computing device to execute a method for imputing missing values so as to analyze a data matrix, wherein the data matrix comprises a plurality of data transactions and a plurality of data attributes, and the method comprises:
finding a plurality of complete data transactions and a plurality of incomplete data transactions from the data matrix, each incomplete data transaction comprising at least one unknown data;
respectively obtaining at least one target data transaction approximate to each incomplete data transaction from the complete data transactions;
obtaining at least one known data from the at least one target data transaction corresponding to the incomplete data transaction according to an attribute position of each unknown data in the incomplete data transaction, and using the at least one known data to compute an initial estimated data;
using the initial estimated data to replace the corresponding unknown data and serve as a plurality of data to be corrected;
designating a specific data to be corrected from the data to be corrected, the transaction to which the specific data to be corrected belongs being a correction data transaction;
selecting a first designated data attribute having the most approximate variation with the specific data to be corrected from the data attributes, and finding a data transaction group comprising the correction data transaction according to data in the transaction to which the specific data to be corrected belongs in a manner of grouping same data into one group;
selecting a second designated data attribute having a secondary approximate variation with the specific data to be corrected from the data attributes, and dividing the data transactions into a plurality of subgroups according to an attribute combination of the attribute to which the specific data to be corrected belongs and the second designated data attribute in a manner of grouping same data into one group;
finding at least one target group having data matching the data transaction group from the subgroups, and using data of the specific data attribute to be corrected corresponding to the at least one target group to compute an imputed data for imputing the attribute of the specific data to be corrected; and
judging whether the transaction to which the specific data to be corrected belongs has other data to be corrected, so as to determine whether to designate another specific data to be corrected.
